(19) United States
(12) Patent Application Publication
(10) Pub. No.: US 2010/0107896 A1
(43) Pub. Date: May 6, 2010

(54) FRAME FOR AN UPPER CONTACT GRILLING OR ROASTING PLATE

(75) Inventors: Kay SCHOLZ, Hamburg (DE); Otto Langguth, Tangstedt (DE); Karsten Anklam, Bargteheide (DE)

Correspondence Address: VENABLE LLP, P.O. BOX 34385, WASHINGTON, DC, 20043-9998, US

(73) Assignee: H.H. Scholz KG, Hamburg (DE)

(21) Appl. No.: 12/365,637

(22) Filed: Feb. 4, 2009

(30) Foreign Application Priority Data
Nov. 5, 2008 (DE) 10 2008 056 476.1

(51) Int. Cl. A47J 37/06

(52) U.S. Cl. 99/372; 99/426

(57) ABSTRACT

The invention concerns a frame having a horizontally directed stabilising means and a vertically directed supporting means, the frame being adapted and designed for pivotable attachment of an upper contact grilling or roasting plate.

### CROSS-REFERENCE TO RELATED APPLICATIONS

This application claims the priority of German patent application DE 10 2008 056 476.1, filed on Nov. 5, 2008, the subject matter of which is incorporated herein by reference.

### BACKGROUND OF THE INVENTION

The invention concerns a frame for an upper contact grilling or roasting plate.

It is known that grilling or roasting devices have a grilling or roasting plate on which is placed the material to be grilled or roasted. These grilling or roasting devices can be operated, namely in particular heated, electrically, by gas or in some other ordinary manner. By means of these grilling or roasting plates, the material can be grilled or roasted on one side only. For grilling or roasting the second side, the material must be turned. This has the drawback of a longer grilling or roasting time and an uneven grilling or roasting process. In the event that treatment at the same time, that is, grilling or roasting of two sides of the product at the same time, is desired, the existing grilling or roasting device must be replaced by a contact grilling or roasting device which consists of an upper contact grilling or roasting plate and a lower contact grilling or roasting plate, the upper contact grilling or roasting plate being pivotable relative to the lower contact grilling or roasting plate, so that the upper contact grilling or roasting plate is pivotable out of a standby position into a working position and vice versa. Complete replacement of the whole grilling or roasting unit is, however, very cost-intensive. Moreover, existing contact grilling or roasting devices such as are known from for example EP 0 662 299 B1 with an upper contact grilling or roasting plate and a lower contact grilling or roasting plate are not very space-saving either, because due to the pivotable arrangement a free space is necessary behind the contact grilling or roasting plates in order to allow the free pivot movement. To put it another way, existing contact grilling or roasting devices cannot be positioned directly on a rear boundary, namely usually a wall or the like.

### SUMMARY OF THE INVENTION

It is therefore the object of the present invention to eliminate the drawbacks existing in the state of the art.

This object is achieved by a frame having a horizontally directed stabilising means and a vertically directed supporting means, the frame being adapted and designed for pivotable attachment of an upper contact grilling or roasting plate. As a result, in a surprisingly simple manner an existing grilling or roasting unit which has only one grilling or roasting plate can be upgraded to a contact grilling or roasting device for simultaneously grilling or roasting two sides of a product (upper side and lower side).

An appropriate development of the invention is distinguished in that the horizontally directed stabilising means has at least three parallel and spaced-apart struts, the two struts on the outside being shorter than the or each strut located between the two struts on the outside. With this design it is particularly simple to fit an upper contact grilling or roasting plate reliably and safely to an existing ordinary grilling or roasting plate. With the two outer struts, the frame can be attached particularly safely to the existing grilling or roasting plate, while the (centre) strut with the longer length located between the two outer struts produces or has a particularly good stabilising effect.

Preferably, the frame is in several parts and consists of two end pieces and at least one centre piece, the end pieces and the or each centre piece being capable of connection to each other by suitable fastening elements. Due to this modular construction, the two end pieces and one centre piece or several centre pieces can be combined as desired, so that an individually adapted frame can be produced, to which can be attached a single upper contact grilling or roasting plate or several upper contact grilling or roasting plates. In other words, due to the construction according to the invention the frame is capable of being adapted to different sizes of existing grilling or roasting plates.

A particularly preferred embodiment of the invention is distinguished in that the frame according to any of claims 1 to 8 is provided with an upper contact grilling or roasting plate which is pivotably connected to the frame. As a result, an independent grilling or roasting device is produced, which can be fastened in particular as a conversion kit to all common, one-sided grilling or roasting devices, regardless of their construction and manner of operation.

Advantageously, the frame has a centre arm by which the upper contact grilling or roasting plate is pivotably linked to the frame. With this design, particularly individual conversion is ensured.

A development according to the invention is characterised in that a vertically directed supporting section of the centre arm is attached rigidly but releasably to the vertically directed supporting means, while a holding section of the centre arm with the upper contact grilling or roasting plate is arranged pivotably on the supporting section. As a result, particularly easy and reliable handling is achieved. Due to the fact that the supporting section is rigidly connected, the number of moving parts is reduced, thus increasing the length of life of the component parts. Due to the capacity of the connection for release, individual adaptation can be ensured to increase the individuality. In particular, the supporting means of the centre arm is adjustable in height, so that the distance between the upper contact grilling or roasting plate and any base, but in particular any lower grilling or roasting plate, is variable.

A particularly preferred embodiment of the invention is characterised in that the pivot shaft of the holding section is formed or arranged approximately at the point of intersection of the centre axes of the holding section on the one hand and the supporting section on the other hand. With this centrally arranged pivot shaft, a particularly space-saving embodiment can be achieved, because during pivoting about the pivot shaft the holding section does not protrude rearwardly beyond the supporting means. In other words, the frame with the upper contact grilling or roasting plate can be moved close up to a boundary, for example a wall, without hindering the pivot operation. The frame with the upper contact grilling or roasting plate can, due to the design according to the invention, even be fastened to a wall or the like and form a grilling or roasting device independently or in combination with a lower grilling or roasting plate.

### BRIEF DESCRIPTION OF THE DRAWINGS

Further appropriate and/or preferred features and developments of the invention are apparent from the subsidiary claims and the description. Particularly preferred embodiments are described in more detail with the aid of the attached drawings. The drawings show:

FIG. 1 a single-part frame,

FIG. 2 a multi-part, modular frame,

FIG. 3 the single-part frame having a centre arm, and

FIG. 4 the single-part frame having a centre arm as in FIG. 3, an upper contact grilling or roasting plate being associated with the centre arm.

### BRIEF DESCRIPTION OF THE EMBODIMENTS

The frame shown in the figures as well as the unit composed of frame, centre arm and upper contact grilling or roasting plate serve in particular to convert already existing grilling or roasting plates. Each frame or each above-mentioned unit is however also suitable for use as an independent unit, as an exchange part or as a replacement part.

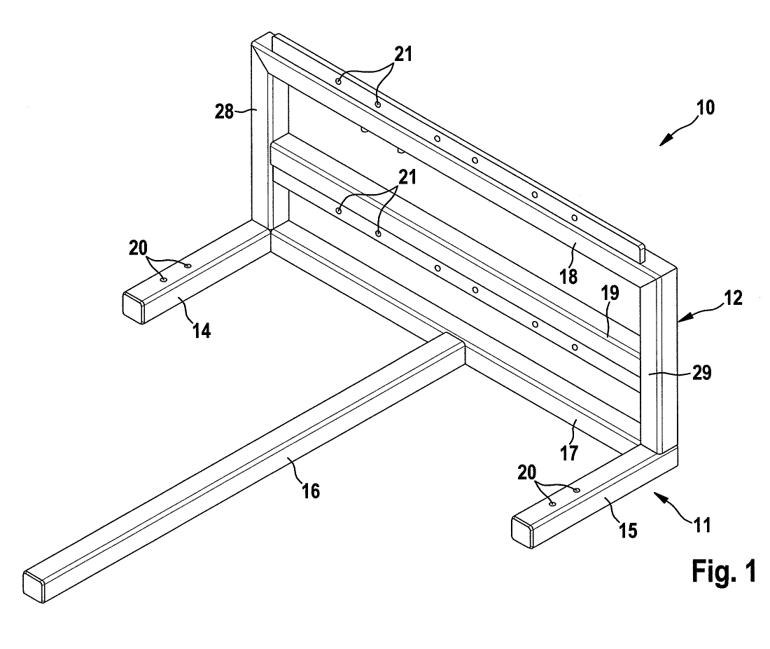

The frame 10 shown in perspective in FIG. 1 is constructed in one piece. This means that the frame 10 has a definite construction with fixed dimensions, the dimensions not being fixed to a single size. The frame 10 has a horizontally directed stabilising means 11 and a vertically directed supporting means 12. The horizontal orientation relates to a plane E usually spanned by a base, a table or the like. The horizontal and vertical orientations expressly also include approximately horizontal and vertical orientations. The frame 10 itself is adapted and designed for the pivotable fastening of an upper contact grilling or roasting plate 13. This means that the frame 10 is suitable with respect to its structural design and material construction to hold and fix an upper contact grilling or roasting plate usually located with respect to weight above its own weight, in a stable and deformation-resistant manner.

The frame 10 is preferably made of a metal. Particularly preferred are stainless steels. Furthermore, however, the frame 10 can be made of a plastic or other materials or combinations of materials with comparable material properties. Particularly preferably, the material from which the frame 10 is made is permitted for foodstuffs.

The horizontally directed stabilising means 11 has at least three preferably parallel and spaced-apart struts 14, 15, 16. The two struts 14, 15 on the outside are shorter than the strut 16 located between the two struts on the outside 14, 15, the so-called centre strut. In further embodiments the struts 14 to 16 can also be the same length or have different lengths. There is also the possibility of the struts 14 to 16 running obliquely to each other. Also more than one (centre) strut 16 can be provided. Preferably all the struts 14 to 16 of the horizontally directed stabilising means 11 can, however, be located in one plane E already defined above. In particular embodiments, individual struts 14 to 16 or all struts 14 to 16 can also be cranked or otherwise shaped.

The vertically directed supporting means 12 has at least two preferably parallel and spaced-apart struts 17, 18. Particularly preferably, three struts 17, 18, 19 are provided. The number of struts of the supporting means 12 can vary, however. One of the struts 17 to 19, preferably the strut 17 defined as the lower strut, connects the struts 14 to 16 of the stabilising means 11 to each other. The struts 17 to 19 of the vertically directed supporting means 12 are connected to each other by vertical struts 28, 29. The definition “at the bottom” is random and can also mean “at the top”. All struts 17 to 19 of the vertically directed supporting means 12 are preferably located in one plane Eᵥ. The plane Eᵥ is preferably oriented at a right angle to the plane E of the stabilising means 11. The angle between the planes E and Eᵥ may however also vary.

At least the struts 14, 15 on the outside of the stabilising means 11 have openings 20 for fastening elements. The openings 20, preferably bores and/or oblong holes, are vertically oriented relative to the plane E, so that the frame 10 can be fastened by means of screws or the like to a lower grilling or roasting plate (not shown). Preferably openings 21 for fastening elements are also provided in the struts 17 to 19, particularly preferably in struts 18 and 19. The openings 21, preferably likewise bores and/or oblong holes, are vertically oriented relative to the plane Eᵥ, so that the frame 11 or, to be more precise, the supporting means 12 can be connected to a component described below.

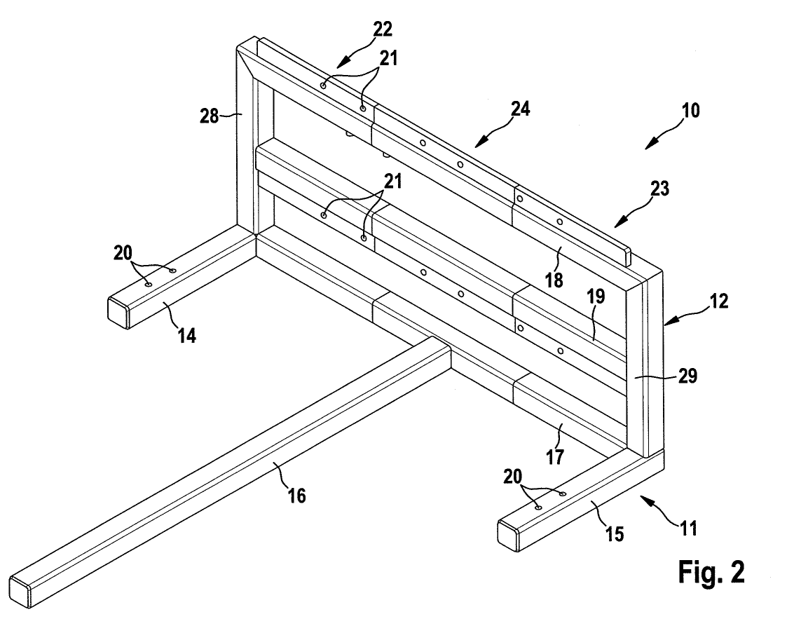

The frame 10 shown in FIG. 2 is basically designed comparably to the frame 10 as in FIG. 1, so that reference is made to the description for FIG. 1 to avoid repetition. Identical parts have the same reference number. However, the frame 10 in FIG. 2 is in several parts. This means that the frame 10 is assembled in modular fashion and can be altered almost as desired. The frame 10 shown consists of two end pieces 22 and 23 and a centre piece 24. The centre piece 24 can, as an alternative to the embodiment shown, have vertically directed struts which connect the horizontal strut sections to each other. The two end pieces 22 and 23 and the centre piece 24 are connected to each other with suitable fastening elements. Suitable fastening elements are preferably screw connections or the like. Between the end pieces 22, 23 can also be arranged several centre pieces 24 and/or adapter pieces (not shown) for extending the frame 10.

The two end pieces 22, 23 each hold an outer strut 14, 15 of the stabilising means 11. The or each centre piece 24 carries at least one (centre) strut 16. The width of the end pieces 22, 23 and the width of the or each centre piece 24 is preferably the same. The width relates to the dimension in the longitudinal direction of the centre axes M of the struts 17 to 19 of the supporting means 12. Thus as it were a kind of grid module can be produced, so that by adding or removing in particular centre pieces 24, adaptation to common widths of existing lower grilling or roasting plates is made possible.

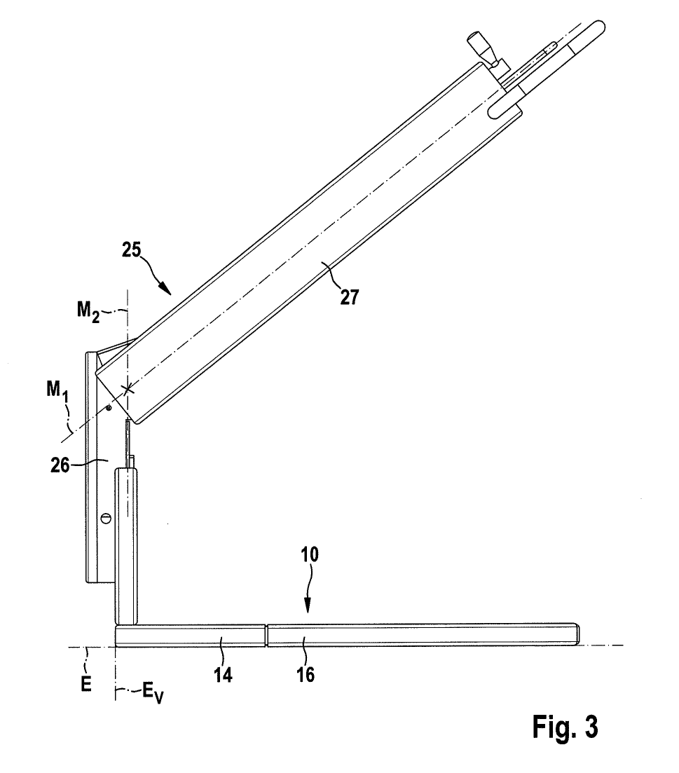

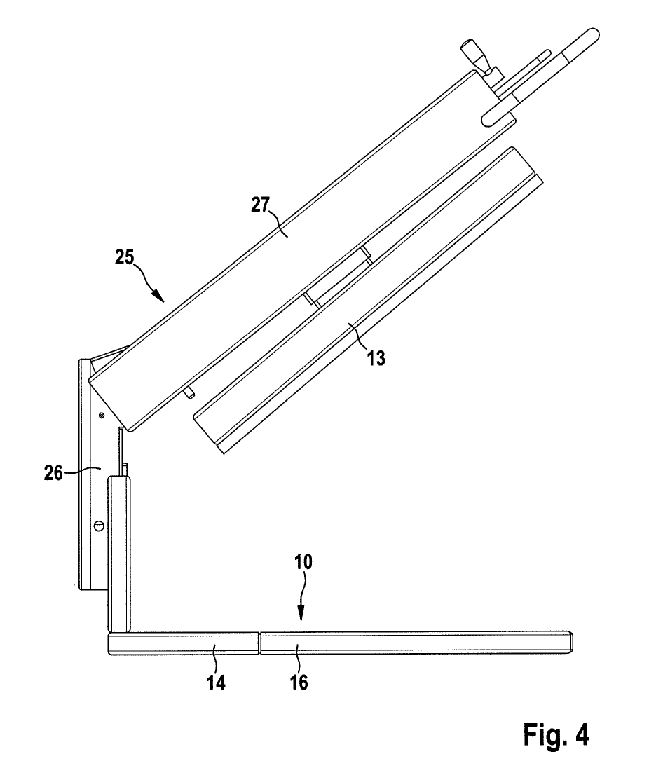

The frame 10 described above is optionally provided with an upper contact grilling or roasting plate 13 which is pivotably connected to the frame 10. As can be seen from FIG. 3, the frame 10 can have a centre arm 25. The centre arm 25 has a vertically directed supporting section 26 and a holding section 27 arranged pivotably on the supporting section 26. The supporting section 26 is fastened rigidly but releasably to the vertically directed supporting means 12 of the frame 10. By the centre arm 25, the upper contact grilling or roasting plate 13 is pivotably linked to the frame 10 (see FIG. 4). The supporting section 26 of the centre arm 25 can be fastened to the supporting means 12 so as to be variable in height. Depending on the size of the frame 10, that is, in particular depending on the number of centre pieces 24, several centre arms 25 can be fastened to the frame 10, so that several upper contact grilling or roasting plates 13 can be mounted on the frame.

With respect to the design of the supporting section 26, different embodiments are possible. Particularly preferred is an embodiment in which the pivot shaft of the holding section is formed or arranged approximately at the point of intersection of the centre axes M₁ and M₂ of the holding section 27 on the one hand and the supporting section 26 on the other hand. But the supporting section 26 can also be cranked or otherwise shaped, the pivot shaft then being formed or arranged e.g. outside the centre axis of the supporting section 26.

1. A frame for a grill, comprising:
a horizontally directed stabilizing element and a vertically directed supporting element,
wherein the frame is configured for pivotable attachment of an upper contact grilling or roasting plate.

2. The frame of claim 1, wherein the horizontally directed stabilizing element comprises at least three parallel and spaced-apart struts, including two outside struts that are relatively shorter than at least one middle strut located between the two outside struts.

3. The frame of claim 2, wherein all the struts of the horizontally directed stabilizing element lie in one plane E.

4. The frame of claims 2, wherein the vertically directed supporting element comprises at least two parallel and spaced-apart struts,
wherein at least one of the spaced-apart struts of the vertically directed supporting element connects the struts of the horizontally directed stabilizing element to each other.

5. The frame of claim 4, wherein all the struts of the vertically directed supporting element lie in one plane Eᵥ,
wherein plane Eᵥ is oriented approximately at a right angle to plane E.

6. The frame of claims 2, wherein at least the outside struts of the horizontally directed stabilizing element have openings for fastening elements.

7. The frame of claims 4, wherein the frame comprises two end pieces and at least one centre piece,
wherein the end pieces and the at least one centre piece are configured to fasten to each other.

8. The frame of claim 7, wherein the end pieces and at least each of the at least one centre piece include a definite width in a longitudinal direction of centre axes M of the struts of the vertically directed supporting element.

9. A combination comprising the frame of claim 1 and an upper contact grilling or roasting plate pivotably connected to the frame.

10. The combination of claim 9, further including centre arm pivotably connecting the frame to the upper contact grilling or roasting plate.

11. The combination of claim 10, wherein the centre arm includes:
a vertically directed supporting section rigidly and releasably attached to the vertically directed supporting element; and
a holding section connected to the upper contact grilling or roasting plate and arranged pivotably on the vertically directed supporting section.

12. The combination of claim 11, wherein the holding section includes a pivot shaft positioned approximately at a point of intersection of a centre axis of the holding section and a centre axis of the vertically directed supporting section.
